(19) United States
(12) Patent Application Publication
(10) Pub. No.: US 2026/0318587 A1
(43) Pub. Date: Oct. 15, 2026

(54) REFRIGERATOR

(71) Applicant: LG ELECTRONICS INC., Seoul (KR)

(72) Inventor: Kyungho HA, Seoul (KR)

(21) Appl. No.: 19/706,783

(22) Filed: Jun. 12, 2026

Related U.S. Application Data
(63) Continuation of application No. 18/023,592, filed on Nov. 11, 2021.

(30) Foreign Application Priority Data
Dec. 1, 2020 (KR) 10-2020-0165599

(51) Int. Cl. F25D 23/02; F25D 23/06

(52) U.S. Cl. CPC F25D 23/028; F25D 23/062

(57) ABSTRACT

The present disclosure relates to a refrigerator and the refrigerator includes a cabinet configured to form a storage space, a door configured to open and close the storage space, and an accommodation member configured to be provided inside the cabinet and to accommodate food therein, in which the accommodation member includes a transparent base resin, and an antibacterial agent consisting of a zirconium phosphate-based carrier on which a silver (Ag) component is carried.

### CROSS-REFERENCE TO RELATED PATENT APPLICATIONS

This application is a continuation of U.S. patent application Ser. No. 18/023,592, filed Feb. 27, 2023, which is a U.S. National Stage Application under 35 U.S.C. § 371 of PCT Application No. PCT/KR2021/016447, filed Nov. 11, 2021, which claims priority to Korean Patent Application No. 10-2020-0165599, filed Dec. 1, 2020, whose entire disclosures are hereby incorporated by reference.

### TECHNICAL FIELD

The present disclosure relates to a refrigerator.

### BACKGROUND ART

In general, a refrigerator is a home appliance that has a storage space shielded by a door to store food at a low temperature and can store the stored food in an optimal state by cooling the air using the refrigerant circulation cycle and allowing the cooled air to circulate in the storage space.

There is always a lot of moisture inside the refrigerator, and the growth of microorganisms such as mold and bacteria is easy according to the type of the stored material, the amount of the storage material, the storage condition of the storage material, and the like.

When microorganisms grow inside the refrigerator, there are problems that the freshness of the stored material is easily deteriorated, the hygiene is not very good, components constituting the inside of the refrigerator, for example, a shelf, a vegetable box, a refrigerator liner, which are made of resin are discolored, and the like.

In order to solve the conventional problems, antibacterial properties are imparted to the resin for making refrigerator components by using organic antibacterial agent or inorganic antibacterial agent such as zinc (Zn)-based or copper (Cu)-based antibacterial agents. In other words, the refrigerator components were produced by extruding the resin for making the refrigerator components in state where the antibacterial agent directly mixed with the resin.

In Korean Patent Publication No. 1995-0002855, the configuration in which an antibacterial and antifungal composition comprising an antibacterial agent formed by mixing and attaching silver and copper, which are antibacterial metal ions, to the surface of zeolite particles and then coating the surface with liquid paraffin is disclosed.

However, in this prior art, metal ions that inhibit the transparency of plastic resins such as copper and zinc is contained, so it is difficult to apply to resin compositions applied to shelves or vegetable boxes that require transparency to check food stored therein.

In addition, in the case of an antimicrobial agent containing an excessive amount of silver ions to secure antibacterial properties, there is a problem of toxicity due to high elution properties.

### DISCLOSURE

### Technical Problem

An object of the present disclosure is to provide a refrigerator including an accommodation member that contains an antibacterial agent containing silver ions in a transparent plastic resin and exhibits an excellent antibacterial function without impairing transparency.

An object of the present disclosure is to provide a refrigerator that is not harmful to the human body by controlling the amount of silver (Ag) ions eluted from the accommodation member.

### Technical Solution

The refrigerator according to an embodiment of the present disclosure includes an accommodation member configured to be provided in a storage space to accommodate food, in which the accommodation member is made of a transparent plastic resin including an antibacterial agent formed by carrying a high content of silver ions on a zirconium-based carrier.

The refrigerator according to an embodiment of the present disclosure includes a cabinet configured to form a storage space, a door configured to open and close the storage space, and an accommodation member configured to be provided inside the cabinet and to accommodate food therein, in which the accommodation member includes a transparent base resin, and an antibacterial agent consisting of a zirconium phosphate-based carrier on which a silver (Ag) component is carried.

The transparent base resin may be at least one selected from the group consisting of general-purpose polystyrene (GPPS), polypropylene (PP), styrene-acrylonitrile (SAN), acrylonitrile butadiene styrene (ABS), polyethylene terephthalate glycol (PETG), polycyclohexylenedimethylene terephthalate (PCT), polymethyl methacrylate (PMMA), and polycarbonate (PC) resin.

The transparent base resin may be general-purpose polystyrene (GPPS) containing 75 to 99% by weight of a styrene monomer and 1 to 25% by weight of ethylbenzene.

The carrier may further include a compound (A) containing an alkali metal, a compound (B) containing a tetravalent metal, and a compound (C) containing a phosphoric acid group.

The molar ratio (A:B:C) of the compound (A) containing the alkali metal, the compound (B) containing the tetravalent metal, and the compound (C) containing the phosphoric acid group in the carrier may be 0.5-2:2-6:4-8.

The carrier may be heat-treated in the range of 1,000° C. to 1,600° C.

The accommodation member may not contain zinc (Zn) or copper (Cu).

The silver (Ag) component in the antibacterial agent may be contained in an amount of 5 to 15% by weight based on 100% by weight of the antibacterial agent.

The antibacterial agent may be contained in an amount of 0.001 to 1% by weight based on 100% by weight of the transparent base resin.

The particle size (D50) of the antibacterial agent may be 0.1~10 μm.

The accommodation member may have an antibacterial performance of 99.9% or more measured according to the JIS Z 2801:2010 film adhesion method.

The accommodation member may have an elution amount of silver ions of 1 ppb/day or less.

The transparency of the accommodation member measured by the method according to ASTM D1003 may be 12% or less.

The refrigerator may further include a display part configured to display operating conditions or operating states of the refrigerator on one side of the front surface of the door, in which the display part may include the transparent base resin and the antibacterial agent.

### Advantageous Effects

The refrigerator according to an embodiment of the present disclosure includes an accommodation member containing an antibacterial agent containing silver ions and has improved sterilization and antibacterial functions, so that the stored material stored therein can be kept fresh.

In addition, according to an embodiment of the present disclosure, since the antibacterial agent does not contain metal ions that impair transparency, such as zinc (Zn) or copper (Gu), there is an advantage that it is possible to provide a refrigerator including an accommodation member having excellent transparency.

In addition, the accommodation member has an advantage in that silver ions are eluted at a certain range or less, thereby providing a refrigerator harmless to the human body.

The refrigerator according to the embodiment of the present disclosure includes an accommodation member having excellent transparency and antibacterial properties and has the advantage of being able to visually check the stored material from the outside while keeping the stored material more hygienic and fresh.

### DESCRIPTION OF DRAWINGS

FIG. 1 is a front view illustrating a refrigerator according to an embodiment of the present disclosure.

FIG. 2 is a view illustrating a state where the door of the refrigerator is opened.

FIG. 3 is a photomicrograph illustrating a specimen prepared by a method of mixing the antibacterial agent in the compounding process of the base resin.

FIG. 4 is a photomicrograph illustrating a specimen prepared by mixing the antimicrobial agent in the form of a master batch with the base resin.

### MODE FOR INVENTION

Hereinafter, specific embodiments of the present disclosure will be described in detail with drawings. However, the present disclosure cannot be said to be limited to the embodiments in which the spirit of the present disclosure is presented, and other disclosures that are degenerative by addition, change, deletion, or the like of other components or other embodiments included within the teaching range of the present disclosure can be easily suggested.

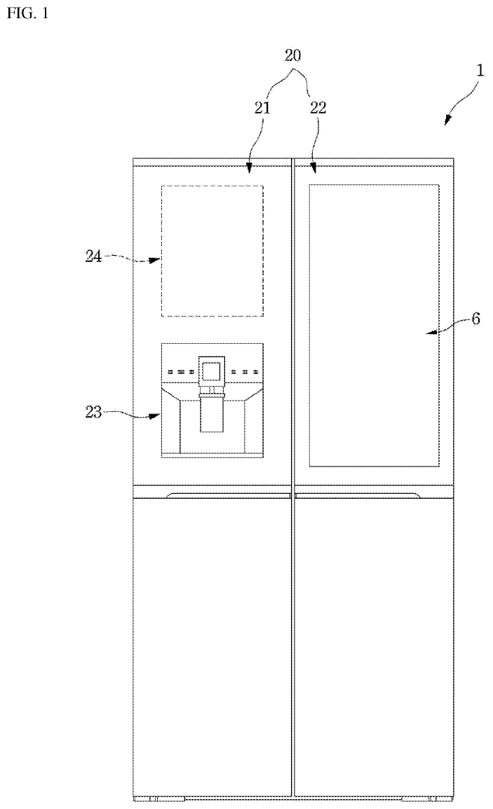

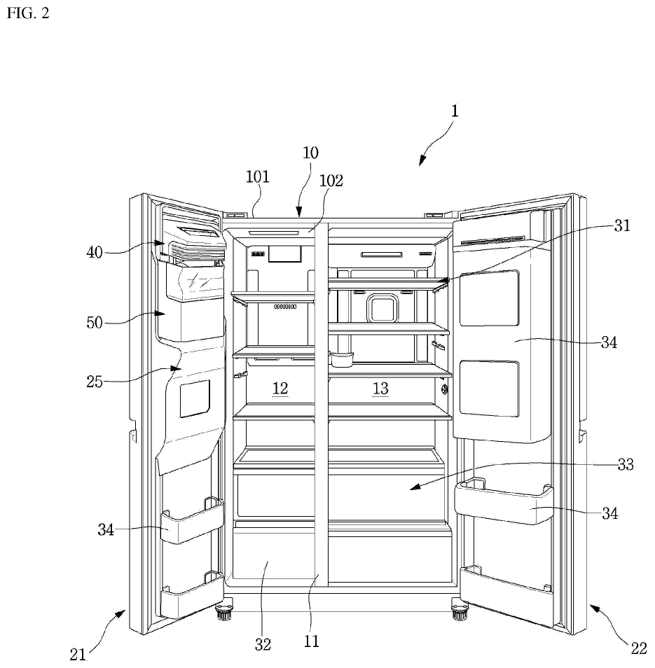

FIG. 1 is a front view illustrating a refrigerator according to an embodiment of the present disclosure, and FIG. 2 is a view illustrating a state where the door of the refrigerator is opened.

As illustrated in the drawing, the refrigerator 1 according to an embodiment of the present disclosure may have an outer appearance formed by a cabinet 10 forming a storage space and a door 20 opening and closing the storage space of the cabinet 10.

For convenience of explanation and understanding, in the following, the direction in which the door 20 is disposed in the refrigerator 1 is defined as the front, the direction in which the cabinet 10 shielded by the door 20 is disposed is defined as the rear, the direction toward the ground is defined as downward, and the direction opposite to the ground is defined as upward.

The cabinet 10 may be composed of an outer case 101 made of a metal material forming an outer surface, and an inner case 102 coupled to the outer case 101 and forming a storage space inside the refrigerator 1. In addition, an adiabatic material is filled between the outer case 101 and the inner case 102 to insulate the space inside the refrigerator.

The storage space is partitioned left and right with respect to the barrier 11 and may include a freezing chamber 12 on the left side and a refrigerating chamber 13 on the right side. In addition, a plurality of shelves and drawers are provided in the freezing chamber 12 and the refrigerating chamber 13 formed by the inner case 102 to independently provide a space for storing food.

The door 20 may include a refrigerating chamber door 22 and a freezing chamber door 21 that independently open and close the refrigerating chamber 13 and the freezing chamber 12, respectively. Both the refrigerating chamber door 22 and the freezing chamber door 21 may open and close the refrigerating chamber 13 and the freezing chamber 12 by a hinge device.

In addition, various accommodation members such as a shelf 31, a drawer 32, a vegetable box 33, or a door basket 34 may be provided inside the refrigerating chamber 13 and the freezing chamber 12. The accommodation member, if necessary, may be drawn in and out in a state where the door is opened, and can accommodate and store food by drawing in and out.

In detail, a plurality of shelves 31 are disposed inside the refrigerating chamber 13 and the freezing chamber 12 to place food or a container containing food. At least a portion of the shelf 31 may be made of a transparent material. In addition, the shelf 31 may be formed of a transparent plastic resin containing the antibacterial agent.

In addition, the refrigerating chamber 13 or the freezing chamber 12 may include a vegetable box 33 formed to be partitioned from another space in order to store foods such as vegetables and fruits while maintaining freshness for a long period of time.

In detail, the vegetable box 33 may form a vegetable chamber by providing a drawer and a cover formed to partition with other spaces in order to keep foods such as vegetable and fruits fresh for a long time in the refrigerating chamber 13. In addition, the vegetable box 33 may be formed so as to be able to draw in and out from the inside of the refrigerating chamber 13 or the freezing chamber 12.

At least a portion of this vegetable box 33 is formed of a transparent plastic material that can see through the inside and thus the user can easily check the food stored inside the vegetable box 33.

In addition, a plurality of door baskets 34 may be provided in the refrigerating chamber door 22 and the freezing chamber door 21, and the door basket 34 may be configured so as not to interfere with the accommodation members provided in the refrigerator in a state where the refrigerating chamber door 20 and the freezing chamber door 30 are closed. In addition, the door basket 34 may be able to see through the inside so that the stored food can be easily checked from the outside and may be made of a transparent plastic material containing an antibacterial agent.

Meanwhile, a dispenser 23 and an ice making part 24 may be provided in the pair of the freezing chamber doors 21. In addition, the dispenser 23 and the ice making part 24 may be configured to communicate with each other by the ice chute 25. The ice making part 24 may include at least the ice maker 60 and the ice cover 40 and may further include at least one of the ice bean 50 and the seating member, if necessary.

The ice bin 50 may be formed in a container shape in which ice made by the ice maker 60 is dropped and stored. In addition, a portion of the ice bin 50 can be seen through and may be formed of a transparent plastic material containing the antibacterial agent.

Meanwhile, a display part 6 may be provided on one side of the front surface of the door 20. The display part 6 may display operating conditions or state information illustrating the operating conditions of the refrigerator or may include a manipulation part for inputting operating conditions or state conditions of the refrigerator.

In addition, a display cover for preventing the display from being contaminated by external contaminants may be provided on the display. In addition, the display cover may be made of a plastic material, a film, or the like. Such a display cover may be made of a transparent plastic material containing an antibacterial agent.

Hereinafter, the transparent plastic resin containing the silver-based antibacterial agent according to the present disclosure will be described in detail.

The transparent plastic resin may form at least a part of the refrigerator component which is preferably formed so that the inside thereof can see through. As an example, it may be a vegetable box, a drawer, a basket, and an external display.

The transparent plastic resin composition includes a transparent base resin and a zirconium-based antibacterial agent containing silver.

As the base resin, a resin in which the molded article can exhibit transparency may be used. For example, at least one selected from the group consisting of general-purpose polystyrene (GPPS), polypropylene (PP), styrene-acrylonitrile (SAN), acrylonitrile butadiene styrene (ABS), polyethylene terephthalate glycol (PETG), polycyclohexylenedimethylene terephthalate (PCT), polymethyl methacrylate (PMMA), and polycarbonate (PC) resin may be used.

Specifically, it may be preferable in terms of transparency and mechanical strength to use general-purpose polystyrene (GPPS) as the base resin.

In detail, the base resin may have a tensile strength measured by ASTM D638 of 520 to 590 kgf/cm2, preferably 550 to 580 kgf/cm2, and an elongation measured by ASTM D638 of 1 to 10%, preferably 1 to 5%, and there is an advantage that the processability and mechanical strength of the molded article are excellent within this range.

The base resin may have a flexural strength measured by ASTM D790 of 900 to 1,200 kgf/cm2, preferably 900 to 1,100 kgf/cm2, and a flexural modulus measured by ASTM D790 of 35,000 to 40,000 kgf/cm2, preferably 35,000 to 38,000 kgf/cm2, and has an advantage of excellent processability of the molded article within this range.

The base resin may have an impact strength measured by ASTM D256 of 0.1 to 5 kgf cm/cm, preferably 0.1 to 2 kgf cm/cm, and there is an advantage that the mechanical properties of the molded article are excellent within this range.

The base resin may have a Rockwell hardness measured by ASTM D785, L-Scale of 80 to 120, preferably 90 to 110, and has excellent mechanical properties of the molded article within this range.

The base resin may have a flow index measured by ASTM D1238 of 1 to 5 g/10 min, preferably 2 to 4 g/10 min in 200° C./5 Kg, and a Vicat softening point measured by ASTM D1525, A/50 of 80 to 120° C., preferably 90 to 110° C.

The base resin may have a molding shrinkage measured in ASTM D955 of 0.1 to 1%, preferably 0.4 to 0.7%, and a specific gravity measured in ASTM D792 of 0.50 to 1.5, preferably 0.8 to 1.2. In addition, the base resin may have a water absorption measured in ASTM D570 may be 0.01 to 0.05%. Within this range, there is an advantage of excellent transparency, processability and mechanical strength of the molded article.

Meanwhile, the antibacterial agent may be a carrier including a silver component. Since the carrier including silver ions contains silver ions in a densely dispersed state, when the silver ions are included in the base resin using a carrier, the total surface area of silver per unit area of the base resin molded article can be increased.

As the carrier, zeolite, silica gel, calcium phosphate, zirconium phosphate, glass, or the like can be used, and among these, the use of a zirconium phosphate-based compound has a higher antibacterial effect, and when blended with the base resin, it is preferable that transparency of the base resin can be maintained.

The zirconium phosphate-based compound used as a carrier for the antibacterial agent may contain a compound (A) containing an alkali metal such as lithium, potassium, and sodium, a compound (B) containing a tetravalent metal such as zirconium and titanium, and a compound (C) containing a phosphate group.

In a specific example, the carrier may include a compound (A) containing an alkali metal such as lithium carbonate (Li2CO3) or sodium carbonate (Na2CO3), a compound (B) containing a tetravalent metal such as zirconium oxide (ZrO2), and a compound (C) containing a phosphoric acid group, such as ammonium dihydrogen phosphate (NH4H2PO4).

The carrier can be prepared by mixing the compound (A) containing the alkali metal, the compound (B) containing the tetravalent metal, and the compound (C) containing a phosphoric acid group in a molar ratio (A:B:C) of 0.5 to 2:2 to 6:4 to 8. Preferably, the carrier can be prepared by mixing the compound (A) containing the alkali metal, the compound (B) containing the tetravalent metal, and the compound (C) containing a phosphoric acid group in a molar ratio (A:B:C) of 0.5 to 1.5:3 to 5:5 to 7. Within this range, cracks do not occur in the process of heat treatment of the carrier to be described later, and strength and workability may be excellent.

In addition, the carrier may be heat-treated, that is, sintered at a temperature of 1,000° C. to 1600° C., preferably 1,100° C. to 1,400° C., and it is possible to uniformly disperse silver ions while maintaining antibacterial properties within this range.

When the sintering temperature is lower than 1,000° C., metal oxidizing species may not be reduced, and when the sintering temperature is higher than 1600° C., aggregation and sintering between metal particles occurs, which causes pore points, so that silver ions may not be sufficiently carried in the carrier.

Meanwhile, in the antimicrobial agent according to an embodiment of the present disclosure, an antibacterial metal component having an oligodynamic effect called a microbactericidal action may be carried on the carrier. In detail, metal ions react with thiols (—SH—) of microorganisms or react with cell nuclei to inhibit enzymatic action, or active oxygen or hydroxyl radicals generated by catalysis of the metal ions destroy the protein structure of microorganisms and thus has antibacterial action.

As an example of such an antibacterial metal component, it is preferable to use silver (Ag). Of course, it is possible to inhibit the growth of microorganisms by using metal components such as zinc (Zn) and copper (Cu) that exhibit antibacterial properties, but, as in the present disclosure, in a case where a transparent plastic resin that allows the inside of the molded article to see through is included as the base resin, when a metal component such as zinc (Zn) and copper (Cu) is included, the transparency of the base resin may be reduced. Therefore, in one embodiment of the present disclosure, the silver (Ag) component is carried in a high content on the carrier, and the content range in which the antibacterial agent is added to the base resin can be minimized to minimize the deterioration of the transparency of the base resin.

The content of silver ions included in the antibacterial agent is not particularly limited as long as it can impart antibacterial performance, but the amount of silver ions is 5 to 15% by weight, preferably 9 to 10% by weight, based on 100% by weight of the antibacterial agent.

When the silver ion content is less than 5% by weight, the amount of the antibacterial agent added to the base resin is increased in order to exhibit a necessary antibacterial function, thereby increasing the manufacturing cost of the molded article. In addition, when the content of the silver ions exceeds 15% by weight, aggregation of the antibacterial particles may easily occur, which may make it difficult to knead when preparing the antibacterial agent, and the silver ions may be excessively eluted from the molded article, which may be harmful to the human body.

In other words, the silver ion is included in the antibacterial agent within the above range and is carried in a relatively high content on the carrier, thereby while minimizing the amount of the antimicrobial agent added to the base resin, the transparency of the base resin may be maintained and excellent antibacterial activity can be exhibited.

The blending amount of the antibacterial agent to the base resin may depend on the blending amount of the silver ion of the antibacterial agent, and the antimicrobial agent according to an embodiment of the present disclosure may be 0.001 to 1% by weight, preferably 0.01 to 0.5% by weight, more preferably 0.05 to 0.1% by weight based on 100% by weight of the base resin. Within the above range, excellent antibacterial activity is exhibited at a low cost without impairing the transparency of the base resin, and there is an effect that can improve the hygiene of the molded article.

The average particle diameter (D50) of the antimicrobial agent may be, for example, 0.1 to 10 μm, or 0.1 to 5 μm, preferably 0.1 to 2 μm. Within the above range, it is possible to control the concentration at which the antimicrobial agent is eluted from the molded product within a set range.

The average particle diameter (D50) of the present description may be defined as the cumulative average particle diameter corresponding to 50% by volume in the cumulative distribution curve of the particle size in which the total volume is referred to as 100%. The average particle diameter may be measured by a method known to those skilled in the art and for example, may be measured using a laser diffraction method.

The antimicrobial agent can be obtained by carrying the antimicrobial metal on a carrier by a conventional method. Conventional methods include physical adsorption, chemical adsorption, ion exchange, vapor deposition or surface thin film formation, mechanical carrying method, and the like. For example, the antimicrobial agent may be prepared by an ion exchange method capable of more uniformly distributing silver ions.

In other words, the antibacterial agent according to an embodiment of the present disclosure has advantages that as an antibacterial agent prepared by carrying silver ions (Ag+) on a zirconium ion exchanger using ion exchange technology, the antibacterial agent has little hygroscopicity, has excellent heat resistance, is very stable physically and chemically, and has excellent coloration and discoloration resistance during processing.

Meanwhile, the base resin constituting the molded article may further include a pigment to improve transparency.

It is preferable from the viewpoint of maintaining the transparency of the molded article that in the color difference value of the pigment, L is in the range of 33 to 36, a is in the range of −0.1 to −0.07, and b is in the range of −0.7 to −0.4. Here, L is the degree of gloss, a is the degree of red, and b is the degree of yellow.

The color difference value of the pigment may be measured according to a method generally measured by those skilled in the art, for example, it may be measured by CIE Lab, Konika Minolta Chroma meter CM-3700d D65.

Meanwhile, when the antimicrobial agent is contained in the molded article in a predetermined concentration range, the molded article secures the antibacterial activity desired by the present disclosure, and when extruding or injecting a molded product, if a trace amount of an antimicrobial agent is directly added into the base resin, there is a problem in that it is not evenly dispersed in the base resin.

The antibacterial agent according to an embodiment of the present disclosure may be blended with the base resin in various ways. For example, it may be a method of adding and polymerizing the antimicrobial agent together during polymerization of the base resin, a method of adding an antimicrobial agent during the compounding process, and a method by a master batch.

In detail, according to an embodiment of the present disclosure, during the polymerization process of the base resin, the antimicrobial agent is directly added into the reactor, so that the antimicrobial agent may be dispersed in the base resin. In other words, when the styrene monomer and ethylbenzene, which are raw materials for the base resin, are added to the reactor and polymerized, the antibacterial agent may be added together.

In this case, the polymerization reactor may be, for example, a continuous stirred reactor (CSTR). 75 to 99% by weight of styrene monomer and 1 to 25% by weight of ethylbenzene may be added to the polymerization reactor. In addition, based on 100 parts by weight of the total of the styrene monomer and ethylbenzene, the antimicrobial agent may be added in an amount of 0.01 to 1 parts by weight, preferably 0.05 to 0.5 parts by weight, more preferably 0.05 to 0.1 parts by weight.

In this case, the pigment may be additionally added to the polymerization reactor together with the antimicrobial agent.

In addition, the polymerization may be polymerized in the temperature range of 110 to 140° C., for 3 to 9 hours. In detail, the polymerization may be polymerized by a continuous process of a plurality of reactors, and after the raw material of the base resin and the antibacterial agent are added to the first reactor, the polymerization reaction is carried out at a temperature of 110 to 140° C., for 3 to 5 hours. Thereafter, an additional polymerization reaction may be performed at a temperature of 110 to 140° C. for 3 to 5 hours in the second reactor connected to the first reactor.

In addition, the base resin containing the antimicrobial agent on which the polymerization reaction is completed may be prepared in the form of pellets and may be manufactured into a molded article through an extrusion or injection molding process.

In this way, during polymerization of the base resin, the antibacterial agent is added together, so that the antibacterial agent can be blended together in the polymerization process.

Therefore, the antibacterial agent is uniformly dispersed and high dispersibility can be maximized, and in particular, the molded article produced by the antibacterial agent with a minimum content can secure excellent transparency and antibacterial activity.

Meanwhile, as another example of the present disclosure, in order to improve the dispersibility of the antimicrobial agent in the base resin, the antimicrobial agent may be dispersed in the base resin by a compounding process method.

The compounding refers to a process of producing pellets by adding two or more kinds of solids in a predetermined component ratio, kneading the mixture within a predetermined temperature and a predetermined residence time, and then extruding to the outside, cooling, and cutting.

In one embodiment of the present disclosure, the base resin and the antibacterial agent are added together, and the compounding process may be performed at a temperature higher than the melting temperature of the base resin.

The antimicrobial agent may be added in an amount of 0.01 to 1% by weight, preferably 0.05 to 0.5% by weight, more preferably 0.05 to 0.1% by weight based on 100% by weight of the base resin.

In addition, it is preferable to use a twin extruder for the compounding to improve dispersibility. In addition, by adding the base resin and the antibacterial body into the twin extruder, it can be melt-kneaded at a temperature of 180 to 250° C. In this case, the temperature may be compounded so that the temperature increases as the distance from the raw material input part increases. For example, the twin extruder may be divided into 4 equal parts and may be divided into H1, H2, H3, and H4 in the order closest to the raw material input part, respectively. Here, the temperature of the H1 section may be in the range of 190 to 205° C., the temperature of the H2 section may be in the range of 205 to 215° C., the temperature of the H3 section may be in the range of 215 to 225° C., and the temperature of the H4 section may be in the range of 210 to 220° C.

In this case, the compounded pellets may further add the pigment as well as the base resin and the antibacterial agent.

In addition, the compounded pellets may be manufactured into a molded article through an extrusion or injection molding process.

When producing pellets by this compounding method, the antibacterial agent is added together with the base resin and melt-kneaded together, thereby ensuring high dispersibility.

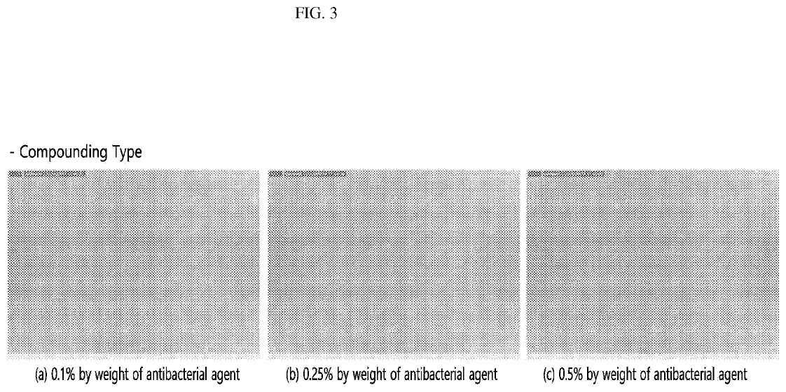

In detail, as illustrated in FIG. 3, when a pellet including an antibacterial agent is prepared by a compounding method, it can be confirmed that the antibacterial agent is uniformly distributed in the pellet. In other words, by directly adding the antimicrobial agent into the compounding process, there is an advantage that antimicrobial properties and transparency can be secured by adding a minimum amount of the antimicrobial agent.

Meanwhile, as another example of the present disclosure, the antibacterial agent can be dispersed in the base resin by using a masterbatch containing the antibacterial agent.

This master batch is prepared to contain a high concentration of the antimicrobial agent in advance so that the antimicrobial agent can be sufficiently dispersed in the base resin, and as a result, can be used to manufacture molded articles in a method for mixing the master batch with the base resin.

In detail, after preparing the masterbatch containing the antimicrobial agent in a high concentration in the first step, the antibacterial masterbatch is mixed with the base resin in a predetermined ratio at the time of extrusion or injection in the second step to prepare a molded article.

In this case, the master batch may be prepared by mixing an antibacterial agent including a carrier on which silver ions are carried, and polymer pellets. Then, the antimicrobial agent and the polymer pellets are melt-mixed, so that the antimicrobial agent can be evenly attached to the polymer pellets.

Here, the polymer pellets may be the base resin constituting the molded article.

In addition, when preparing the antibacterial masterbatch, one or more additives such as a dispersant, a softening agent, an absorbent, a deodorant, and a water repellent may be further included.

Thereafter, the prepared master batch may be added to the base resin, which is a raw material for the molded article, and then kneaded and then extruded or injection molded to manufacture a molded article.

In addition, when the antimicrobial agent is added by the master batch method, it is most preferable in terms of dispersibility to include the antimicrobial agent in an amount of 0.01 to 0.3% by weight based on 100% by weight of the base resin.

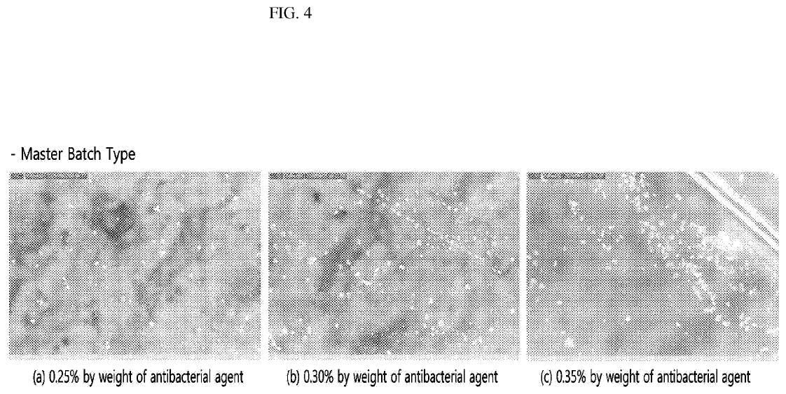

In detail, as illustrated in FIG. 4, when the molded article is manufactured by the master batch method, when the antibacterial agent exceeds 0.35% by weight, it can be confirmed that the dispersibility in the base resin is reduced.

The molded article may be, for example, an accommodation member requiring transparency to check the food stored in the vegetable box, the drawer, the basket, and the like.

In addition, the molded article is a film that shields and protects the display provided on the front surface of the refrigerator and may be a refrigerator component requiring transparency.

In addition, in the molded article, the elution amount of silver ions may be 1 ppb/day or less, and specifically, silver ions may be eluted in the range of 0.3 to 0.6 ppb/day. Therefore, the antibacterial performance of the molded article can be maintained for a long time, and excellent antibacterial activity can be extracted. In addition, even if the food is stored in the molded article for a long time, the silver ion elution amount is maintained within the above range, thereby satisfying the stability of the human body.

The elution amount can be measured by a measurement method commonly used among those skilled in the art, for example, after the specimen is put in ultrapure water and eluted for 24 hours, the metal ions in the ultrapure water can be measured by ICP-MS, but is not limited thereto.

In addition, in the molded article, the transparency (HAZE, %) measured by a method based on ASTM D1003 may be less than 12%, preferably 1 to 1%. Within this range, when the molded article is used as an accommodation member of the refrigerator, it may be possible to see the inside of the accommodation member.

The molded article manufactured according to an embodiment of the present disclosure does not deteriorate the transparency of the molded article even though the molded article contains an antibacterial agent containing silver ions and maintains the transparency thereof as it is, and the antibacterial activity also exhibits an antibacterial effect of 99.9%.

Hereinafter, the content of the present disclosure will be described in more detail by way of Examples.

### Example 1

After 0.05% by weight of Silver Sodium Hydrogen Zirconium Phosphate in powder form with a silver carrying content of 10% in an amorphous GPPS material (granule form cut in water in the cooling process) is added as an antibacterial agent, based on 100% by weight of the GPPS, the material uniformly extruded and cut in the extruder was prepared as a specimen (50×50 mm×2 mm), and then mechanical properties were measured by the following measurement method.

### Comparative Example 1

In Example 1, a specimen was prepared in the same manner as in Example 1, except that the antibacterial agent was not added.

### Measurement Method

Tensile strength (kgf/cm2): It was measured according to ASTM D638.
Elongation (%): It was measured by the method according to ASTM D638.
Flexural strength (kgf/cm2): It was measured according to ASTM D790.
Flexural modulus (kgf/cm2): It was measured according to ASTM D790.
Impact strength (Notched Izod, kgf cm/cm): It was measured according to ASTM D256.
Rockwell hardness (L-Scale): It was measured by the method based on ASTM D785.
Flow index (g/10 min): It was measured according to ASTM D1238 (200° C./5 Kg).
Vicat softening point (° C.): It was measured according to ASTM D1525 (A/50).
Mold shrinkage (%): It was measured according to ASTM D955.
Specific gravity (−): It was measured according to ASTM D792.
Water absorption (%): It was measured according to ASTM D570.

TABLE 1

| | | | Comparative |
|---|---|---|---|
| Division | Unit | Example 1 | Example 1 |
| Tensile strength | kgf/cm² | 540 | 570 |
| Elongation | % | 3 | 3 |
| Flexural strength | kgf/cm² | 1000 | 1050 |
| Flexural modulus | kgf/cm² | 37000 | 37600 |
| Impact strength | kgf · cm/cm | 1 | 1 |
| Rockwell hardness | — | 100 | 100 |
| Flow index | g/10 min | 3.6 | 3.2 |
| Vicat softening point | °C | 103.2 | 103.2 |
| Mold shrinkage | % | 0.4~0.7 | 0.4~0.7 |
| Specific gravity | — | 1.04 | 1.04 |
| Water absorption | % | 0.03 | 0.03 |

As illustrated in Table 1, in the case of Example 1 in which the antibacterial agent was added, compared to Comparative Example 1 in which the antibacterial agent was not added, it could be confirmed that the workability and mechanical strength were excellent without affecting physical properties such as tensile strength, elongation, flexural strength, or the like.

### Example 2

In Example 1, a specimen was prepared in the same manner as in Example 1, except that 0.1% by weight of the antimicrobial agent was added to the GPPS material.

### Example 3

In Example 1, a specimen was prepared in the same manner as in Example 1, except that 0.25% by weight of the antimicrobial agent was added to the GPPS material.

### Example 4

In Example 1, a specimen was prepared in the same manner as in Example 1, except that 0.5% by weight of the antimicrobial agent was added to the GPPS material.

### Measurement Method

Transparency (HAZE, %): It was measured by the method according to ASTM D1003.
Antibacterial performance: It was measured by the film adhesion method according to JIS Z 2801:2010.

In detail, Stomacher 400 POLY-BAG was used as a standard film, strain 1 (Staphylococcus aureus ATC 6538; Staphylococcus aureus) and strain 2 (Escherichia coli ATCC 8739; Escherichia coli) were inoculated, the test bacterial solution was stationary incubated at a temperature of 35±1° C. and a relative humidity of 90% for 24 hours, and then the number of bacteria per 1 cm2 was measured.

TABLE 2

| | | | | | | Comparative |
|---|---|---|---|---|---|---|
| Division | | | Example 2 | Example 3 | Example 4 | Example 1 |
| Transparency | (%) | | 1 | 7 | 10 | — |
| Antibacterial | strain 1 | Bacteria | 1.0 × 10⁴ | 1.0 × 10⁴ | 1.0 × 10⁴ | 1.0 × 10⁴ |
| performance | (S. Aureus) | number after | | | | |
| | | inoculation | | | | |
| | | Bacteria | <0.63 | <0.63 | <0.63 | 2.5 × 10⁴ |
| | | number after | | | | |
| | | 24 H | | | | |
| | | antibacterial | 4.5 | 4.5 | 4.7 | — |
| | | activity | 99.9%) | (99.9%) | (99.9%) | |
| | strain 2 | Bacteria | 1.0 × 10⁴ | 1.0 × 10⁴ | 1.0 × 10⁴ | 1.2 × 10⁴ |
| | (E. Coli) | numberimme- | | | | |
| | | diately after | | | | |
| | | inoculation | | | | |
| | | Bacteria | <0.63 | <0.63 | <0.63 | 1.1 × 10⁶ |
| | | number after | | | | |
| | | 24 H | | | | |
| | | antibacterial | 6.2 | 6.2 | 6.1 | — |
| | | activity | (99.9%) | (99.9%) | (99.9%) | |

As illustrated in [Table 2], in the case of Examples 2 to 4 containing the antibacterial agent according to an embodiment of the present disclosure, it was confirmed that transparency that does not impair the transparency of the base resin is exhibited.

In addition, it was confirmed that Examples 2 to 4 containing the antibacterial agent according to the present disclosure exhibited 99.9% or more of antibacterial performance compared to Comparative Example 1 which did not contain the antibacterial agent.

### INDUSTRIAL APPLICABILITY

The refrigerator according to an embodiment of the present disclosure includes an accommodation member containing an antibacterial agent containing silver ions in a transparent plastic resin, and has the advantage of exhibiting an excellent antibacterial function without impairing transparency, and thus it has high industrial applicability.

1. A refrigerator comprising:
a cabinet configured to form a storage space;
a door configured to open and close the storage space; and
a wall provided in the storage space,
wherein the wall includes:
a base resin, and
an antibacterial agent including a zirconium phosphate-based carrier and a silver (Ag) component,
wherein the zirconium phosphate-based carrier further includes:
a compound (A) containing an alkali metal,
a compound (B) containing a tetravalent metal, and
a compound (C) containing a phosphoric acid group, and
wherein the antibacterial agent contains neither zinc (Zn) nor copper (Cu),
wherein the antibacterial agent contains the silver (Ag) component in an amount of 9 to 10% by weight of the antibacterial agent, and
wherein the wall contains the antibacterial agent in an amount of 0.05 to 0.1% by weight of the base resin.

2. The refrigerator of claim 1,
wherein the base resin includes at least one of general-purpose polystyrene (GPPS), polypropylene (PP), styrene-acrylonitrile (SAN), acrylonitrile butadiene styrene (ABS), polyethylene terephthalate glycol (PETG), polycyclohexylenedimethylene terephthalate (PCT), polymethyl methacrylate (PMMA), or polycarbonate (PC) resin.

3. The refrigerator of claim 2,
wherein the base resin is a general-purpose polystyrene (GPPS) containing 75 to 99% by weight of a styrene monomer and a remaining 1 to 25% by weight of ethylbenzene.

4. The refrigerator of claim 1,
wherein a molar ratio (A:B:C) of the compound (A) containing the alkali metal, the compound (B) containing the tetravalent metal, and the compound (C) containing the phosphoric acid group in the carrier is 0.5-2:2-6:4-8.

5. The refrigerator of claim 1,
wherein the zirconium phosphate-based carrier is heat-treated to a temperature of 1,000° C. to 1,600° C.

6. The refrigerator of claim 1,
wherein a particle size (D50) of the antibacterial agent is 0.1 μm-10 μm.

7. The refrigerator of claim 1,
wherein the wall has an antibacterial performance of 99.9% or more as measured according to a JIS Z 2801:2010 film adhesion method.

8. The refrigerator of claim 1,
wherein the wall has an elution rate of silver ions of 1 ppb/day or less.

9. The refrigerator of claim 1,
wherein a transparency of the wall as measured according to ASTM D1003 is 12% or less.

10. The refrigerator of claim 1, further comprising:
a display provided on an outer surface of the door,
wherein the display includes the base resin and the antibacterial agent.

11. The refrigerator of claim 1, wherein the wall is formed from a resin composition polymerized by introducing the antibacterial agent during a polymerization reaction of the base resin.

12. The refrigerator of claim 1, wherein the wall is included in at least one of a shelf, a drawer, a box, or a basket received in the storage space.

13. The refrigerator of claim 1, wherein the base resin includes a pigment.

14. The refrigerator of claim 1, wherein compound (A) contains at least one of lithium carbonate (Li2CO3) or sodium carbonate (Na2CO3), compound (B) contains zirconium oxide (ZrO2), and compound (C) contains ammonium dihydrogen phosphate (NH4H2PO4).

15. A refrigerator comprising:
a cabinet configured to form a storage space;
a door configured to open and close the storage space; and
a molded article provided in the storage space or on the door:
wherein the molded article includes:
a base resin, and
an antibacterial agent including a zirconium phosphate-based carrier and a silver (Ag) component,
wherein the zirconium phosphate-based carrier further includes:
a compound (A) containing an alkali metal,
a compound (B) containing a tetravalent metal, and
a compound (C) containing a phosphoric acid group, and
wherein the antibacterial agent contains neither zinc (Zn) nor copper (Cu),
wherein the antibacterial agent contains the silver (Ag) component in an amount of 9 to 10% by weight of the antibacterial agent, and
wherein the molded article contains the antibacterial agent in an amount of 0.05 to 0.1% by weight of the base resin.
